(19) United States
(12) Patent Application Publication
(10) Pub. No.: US 2008/0229950 A1
(43) Pub. Date: Sep. 25, 2008

(54) SEAMLESS IMPRINT ROLLER AND METHOD OF MAKING

(76) Inventors: Ping Mei, Palo Alto, CA (US); Carl P. Taussig, Palo Alto, CA (US); Angeles Marcia Almanza-Workman, Palo Alto, CA (US); Albert H. Jeans, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/688,086

(22) Filed: Mar. 19, 2007

(51) Int. Cl. B41N 3/00

(52) U.S. Cl. 101/375; 101/483; 101/401.1

(57) ABSTRACT

This invention provides a structure and method of forming a seamless imprint roller. The method includes providing a translucent cylindrical core. At least one uniform seamless layer of material is deposited about the cylindrical core. This uniform seamless layer of material is then processed to define a translucent three dimensional imprint pattern seamlessly disposed about the core. The pattern includes at least one structure extending from the core and having one or more elevations. The pattern and more specifically the structures are inherently aligned to one another and the cylindrical core.

### FIELD

This invention relates generally to the field of imprint lithography and, in particular, to a seamless imprint roller and method of providing a seamless imprint roller for use in roll to roll imprint lithography.

### BACKGROUND

Thin film electrical devices such as transistors are increasingly common in electrical components, such as for example video display systems. As the trend of downsizing these structures continues, the tasks of precise fabrication and production tend to become more complex, for consistent and uniform performance between components is highly desirable.

Imprint lithography (also referred to as soft lithography) is an increasingly popular lithography process used in the formation of thin film structures. Imprint lithography permits the forming of features in media where the feature size is smaller than a wavelength of light used for conventional photolithography process. Imprint lithography also permits rapid duplication of an established pattern.

An imprint stamp is a structure that includes an imprinted pattern. When the imprint stamp is urged into contact with a media (e.g. a photopolymer) the pattern is transferred to the media. Typically, the media is cured either during the transfer or immediately thereafter so that the pattern replicated in the media retains its shape and complements the imprint pattern of the imprint stamp.

To enhance the ability for repeated pattern transfer, roll to roll imprint lithography processing is an attractive option. Generally such a roll to roll system operates by applying an ultra-violet (hereinafter “UV”) curable polymer to a flexible web. The polymer coated web is brought into contact with an UV transparent imprint roller so that the pattern carried by the imprint roller is embossed into the UV curable polymer.

A UV lamp mounted within, or adjacent to, the imprint roller irradiates the embossed polymer through the transparent imprint roller and cures the polymer in the region where the web is impinged by the stamp roller. As the web moves continuously, driven by a pickup roller, the embossed polymer patters are released from the rotating stamp and transferred to the web.

The quality of the imprint roller, and more specifically the imprint pattern, is of course directly evident in the quality of the pattern rendered in the UV curable polymer. In general, making the imprint roller includes preparing a master mold with a desired pattern by silicon wafer processing, casting an elastic material in the master mold to produce a master shim, replicating the master shim to produce multiple shims, stitching the shims together to produce a larger imprint template. The stitching may require that extra edge spacing be provided to properly join the shims.

It is worth noting that this templating process is performed in a flat plane, which is to say that the imprint template is a flat sheet. It is also relevant to note that the use of repeated shims requires the imprint pattern to be such that it is definable by repeated areas. A pattern that would repeat only once per revolution of the stamp is not likely something that can be easily provided by multiple stitched together shims, unless each is unique.

From this flat imprint template, a flexible UV transparent elastomer is cast. This flexible cast is then laminated around the circumference of a quartz roller. The fact that the process moves from a flat plane to a round surface introduces many undesirable characteristics. For one, it is quite likely that in the process of laminating the elastomer cast to the roller there will be deformation in that the elastomer cast will either expand or contract.

In addition, features of the imprint may deform as they are altered from their initial flat state to a curve state. This deformation may result in one of, more elements of the imprint not being in the precise or required alignment.

Further, and perhaps most significantly, a flat sheet by definition has edges. When a sheet is rolled to form a cylinder a seam will result where the edges are brought together. Achieving a smooth seam is important to insure proper operation, but is technically difficult. In some instances the imprint pattern is not intended to cross the seam, but this is not viable in all situation. When and where the pattern does cross the seam, alignment at the seam, in addition to smoothness of the seam, become significantly important.

The issues of the seam, and the likelihood of deformation during rolling generally mandate extra spacing be provided within the imprint pattern to provide a margin of tolerance for the seam and any deformation as a result of the rolling. Intentional extra space is of course at odds with the desire to maximize the use of the available space for the thin film devices.

Indeed it is entirely possible that two imprint rollers fabricated from two elastomer casts from the same template may each have slightly different tolerances in the alignment of the imprint structures. These differences can result in thin film devices with different performance characteristics depending on which imprint roller is used at the time.

As a result, the traditional processes do not provide imprint rollers with tolerances as high as might otherwise be desired and/or required with respect to achieving high density thin film devices.

Hence, there is a need for an imprint roller and a method of fabricating an imprint roller that overcomes one or more of the drawbacks identified above.

### SUMMARY

This invention provides a method of producing a seamless imprint roller.

In particular, and by way of example only, according to an embodiment, provided is a method of producing a seamless imprint roller, including: providing a translucent cylindrical core; providing at least one uniform seamless layer of material about the core; processing the at least one layer of material to define a translucent three dimensional imprint pattern seamlessly disposed about the core, the pattern including at least one structure extending from the core, the structure having one or more elevations.

According to yet another embodiment, provided is a seamless imprint roller, including: a translucent cylindrical core; and a translucent three dimensional inherently aligned imprint pattern seamlessly disposed about the core, the pattern including at least one structure extending from the core, the structure having one or more elevations, at least the outer surface of the imprint pattern consisting of a high fluorine content material selected from the group of a fluoropolymer, an amorphous fluoropolymer, and a perfluoropolyether.

### BRIEF DESCRIPTION OF THE DRAWINGS

FIG. 1 is a perspective view of a seamless imprint roller according to at least one embodiment;

FIG. 2 is a high level flow diagram for a method of making a seamless imprint roller as shown in FIG. 1;

FIG. 3 is a general perspective illustration of a deposition process employed in the method of making a seamless imprint roller as shown in FIG. 1;

FIG. 4 is a laser tracking and alignment system as may be used for laser ablation, laser exposure or laser radiation treatment processes in the fabrication of a seamless imprint roller as shown in FIG. 1;

FIG. 5 is a cross section partial view of an imprint roller as in FIG. 1 showing a laser, ablation process in accordance with at least one embodiment;

FIG. 6 is a cross section partial view of an imprint roller as in FIG. 1 showing a laser radiation treatment process in accordance with at least one embodiment;

FIG. 7 is a cross section partial view of an imprint roller as in FIG. 1 showing an alternative laser radiation treatment process in accordance with at least one embodiment; and

FIG. 8 is a cross section partial view of an imprint roller as in FIG. 1 showing a maskless lithography process in accordance with at least one embodiment.

### DETAILED DESCRIPTION

Before proceeding with the detailed description, it is to be appreciated that the present teaching is by way of example, not by limitation. The concepts herein are not limited to use or application with a specific seamless imprint roller or method of producing a seamless imprint roller. Thus, although the instrumentalities described herein are, for the convenience of explanation, shown and described with respect to exemplary embodiments, it will be appreciated that the principles herein may be equally applied in other types of seamless imprint roller and/or methods of producing a seamless imprint roller.

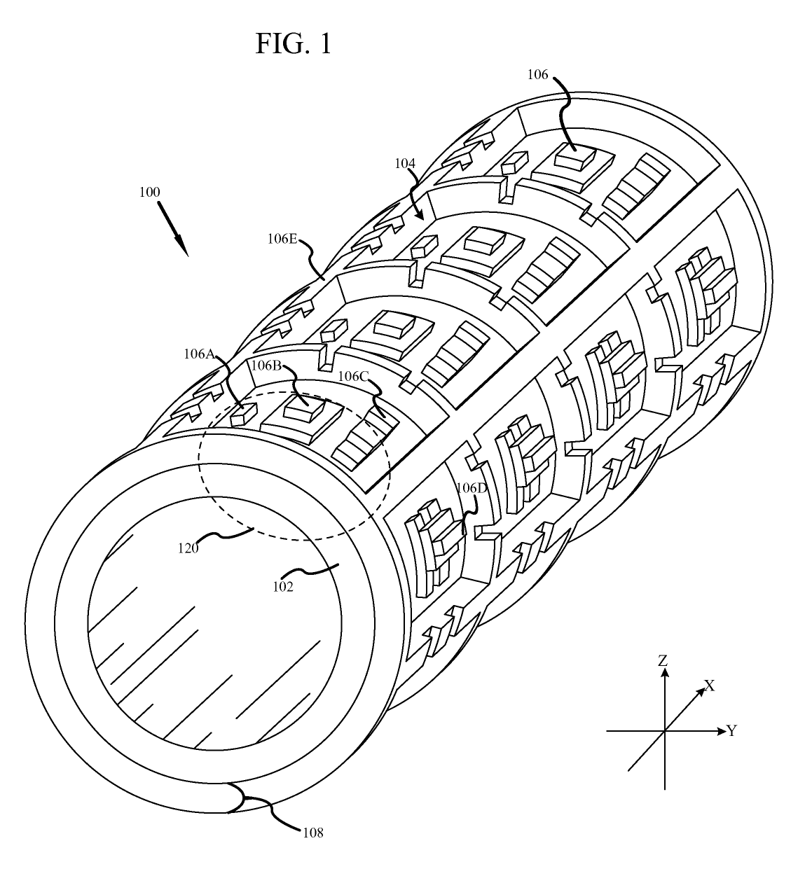

Turning now to the figures, and more specifically FIG. 1, there is shown a perspective view of a seamless imprint roller 100 in accordance with at least one embodiment. Seamless imprint roller 100 has a cylindrical core 102 and a three dimensional imprint pattern 104 seamlessly disposed about the core 102. As shown, the pattern has at least one structure 106 extending from the core 102, the structure 106 having one or more elevations. The imprint pattern 104 is established in at least one uniform seamless layer of material 108 disposed about the core 102.

The seamless imprint roller 100 is applicable for producing a multi-level three dimensional patterned resist layer for use in Self-Aligned Imprint Lithography (“SAIL”), a recently developed technique for producing multilayer patterns on flexible substrates. The basics of this process is set forth and described in U.S. patent application Ser. No. 10/104,567, U.S. Patent Publication Number 04-0002216, the disclosure of which is incorporated herein by reference.

In at least one embodiment the cylindrical core 102 is a UV translucent cylinder. Moreover in at least one embodiment the cylindrical core 102 is a quartz cylinder. In general, the cylindrical core 102 is four to six inches in diameter, though larger or smaller diameters may be utilized as appropriate for different fabrication applications. In addition, the length of the cylindrical core 102 is generally about six to ten inches, but also may vary as appropriate for different fabrication applications. In at least one embodiment, the length is sufficient to establish a desired pattern for the fabrication of an active matrix backplane for use in a display or other device. Further, in at least one embodiment the seamless layer of material 108 is a UV translucent layer of material.

Structures 106A˜106E are exemplary and have been rendered for ease of illustration and description. Structure 106A has a single elevation, structure 106B has two elevations, structure 106C has three elevations, and structure 106D has three elevations. Structure 106E serves as a partial divider between different areas with repetitions of structures 106A˜106C and 106D, and also has three elevations. It is of course understood and appreciated that the actual structures and shapes comprising the imprint pattern 104 will be application specific and can include any pattern that can be formed in at least one uniform seamless layer of material 108.

As is further described below, the imprint pattern 104 of seamless imprint roller 100 is rendered directly upon the core 102. As such there is advantageously no seam. The pattern 104 can be repetitive as shown, or non-symmetrical such that it is only repeated once with each revolution. Further, as structures 106 are rendered directly upon the core, the structures 106 are inherently aligned to each other and to the cylindrical core 102 from the moment they are rendered and remain so throughout the useful life of the imprint roller 100.

In at least one embodiment, at least the outer surface of the imprint pattern 104 consists of a high fluorine content material. Moreover, in at least one embodiment the high fluorine content material is disposed as an outer layer covering upon the imprint pattern 104. In at least one alternative embodiment the uniform seamless layer of material 108 is a high fluorine content material and therefore the structures 106 rendered from the layer are entirely composed of the high fluorine content material.

An additional advantage to using the high fluorine content material to form the uniform seamless layer of material 108 and more specifically the imprint pattern 104 is that a depth d_{F} of the features can be large relative to a width W_{F} of the features in the imprint pattern 104. Accordingly, an aspect ratio (d_{F}/W_{F}) can be large (i.e. d_{F}>>W_{F}) without pairing between adjacent features such as structures 106A˜106C in the imprint pattern 104. A large aspect ratio is particularly desirable when the depth d_{F} is much larger than the minimum feature size λ_{F} (i.e. d_{F}>>λ_{F}) because adjacent features in the imprint pattern 104 stand proud of the seamless imprint roller 100 without pairing (i.e. without sticking to one another) or leaning towards one another.

Desirable properties for the high fluorine content material either coating the structures 106 comprising the imprint pattern 104 or forming the structures 106 in their entirety include an atomic structure comprising carbon (C) and fluorine (F) atoms that are chemically bonded to each other by covalent bonds. An exemplary fluorine content material comprises a backbone of carbon-carbon bonds and carbon-fluorine bonds that form extremely strong covalent bonds between the carbon-carbon bonds and the carbon-fluorine bonds. Moreover, the carbon-fluorine bonds form a sheath around the carbon-carbon bonds that give the high fluorine content material a high resistance to chemical attack (i.e. it is chemically inert) and a low coefficient of friction. PTFE is one example of such a fluorine content material.

The fluorine content material may also include oxygen (O) and chlorine (CI) atoms. For example, perfluoropolymers, including commercially available fluoropolymers, can include oxygen (O) and/or chlorine (CI) atoms that form covalent bonds with the carbon (C) atoms. Perfluorinated polymers are preferable to partially fluorinated polymers because the latter includes hydrogen (H) atoms that bond with the carbon (C) atoms. Consequently, partially fluorinated polymers have undesirable properties including increased hardness and reduced thermal stability relative to perfluorinated polymers.

The high fluorine content material can be a material including but not limited to a fluoropolymer (also referred to as a perfluoropolymer), an amorphous fluoropolymer, a perfluoropolyether (PFPE), and a fluorinated urethane. In the case of fluorinated urethane, for the material to have a low UV absorption, the chemical structure generally is aliphatic with low carbonyl content. As such, in at least one embodiment the fluorinated urethane is aliphatic polyether fluorourethane.

An exemplary high fluorine content material utilized in at least one embodiment includes a DUPONT® Teflon® AF amorphous fluoropolymer. Because the Teflon® AF family of amorphous fluoropolymers are optically transparent to light (including ultraviolet light), have excellent chemical resistance, low thermal conductivity, high molding temperatures, high gas permeability, and have desirable mechanical properties including mechanical strength, a low coefficient of friction, and a high creep resistance. Optical transparency is desirable because it allows a photocurable media to be cured by light that irradiates the media through the high fluorine content material of the imprint pattern 104.

Other suitable fluoropolymers for the high fluorine content material include but are not limited to PTFE and/or PFA. As one example, a Teflon® PTFE or a Teflons PFA material can be used for the high fluorine content material 11. If optical transparency is important, then the amorphous fluoropolymers (e.g. Teflon® AF) have the lowest index of refraction and the highest optical clarity (>95%) when compared to the fluoropolymers PTFE and PFA. The amorphous fluoropolymers are also soluble in selected solvents as described above. Furthermore, perfluoropolyethers (PFPE's) also have desirable polymer properties including mechanical strength, a low coefficient of friction, excellent chemical resistance, and optical transparency.

Chemical resistance is desirable because a chemical reaction between the high fluorine content material of the imprint pattern 104 and the media being embossed by the seamless imprint roller 100 can result in damage, wear, or loss of pattern fidelity in the imprint pattern 104. Finally, the properties of high creep resistance and mechanical strength are desirable so that the imprint pattern 104, and more particularly the seamless imprint roller has a long manufacturing lifetime and a mass production embossing process incorporating the seamless imprint roller 100 is economically viable because a cost of manufacturing the imprint roller 100 can be recovered after several hundred or more embossing steps with the imprint roller 100.

Having described the physical structure of seamless imprint roller 100, methods of producing the seamless imprint roller 100 are now described. It is understood and appreciated that the methods need not be performed in the order herein described, but that these descriptions are merely exemplary of one or more method embodiments.

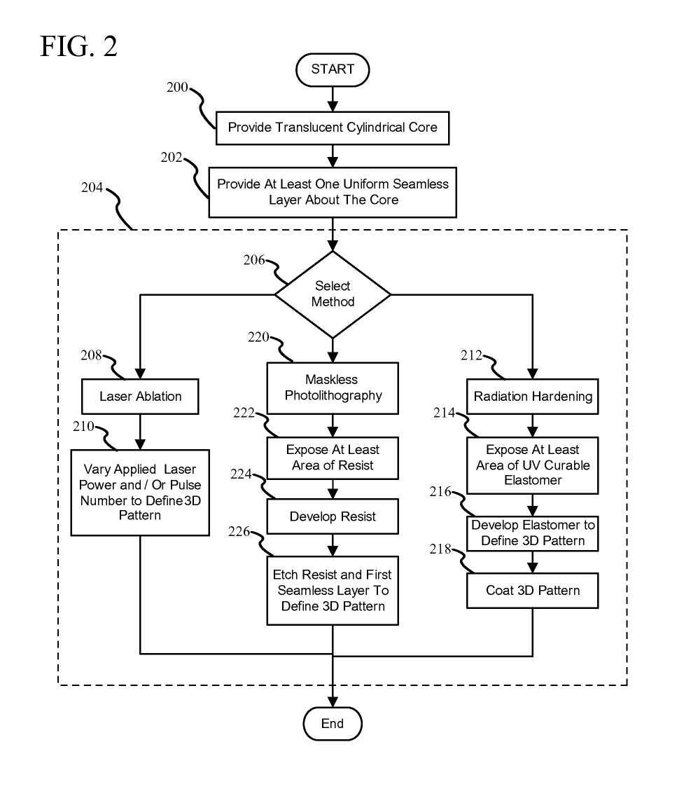

FIG. 2 is a high level flow diagram presenting a method of producing a seamless imprint roller 100 in accordance with at least one embodiment. As shown, the method is initiated by providing a cylindrical core, block 200. In at least one embodiment this is a UV translucent cylindrical core as shown and described above with respect to FIG. 1.

So as to provide the seamless imprint pattern upon the cylindrical core 102, at least one uniform seamless layer of material is provided upon the core, block 202. With at least one seamless layer of material established upon the cylindrical core 102, processing is then performed upon the uniform seamless layer 108 to define a three dimensional imprint pattern 104 seamlessly disposed about the core, dotted block 204. As shown and described with respect to FIG. 1 above, the imprint pattern 104 includes at least one structure 106 extending from the core, and the structure 106 has one or more elevations. It is understood and appreciated that the processing renders the imprint pattern 104 directly upon the core, and as such results in a high advantageous seamless imprint roller 100.

As indicated in FIG. 2 by dotted block 204, there are various different processing methods that may be employed. In at least one embodiment the processing method is selected from the group consisting of laser ablation, maskless photolithography and radiation hardening, each of which is further discussed in detail below.

As is apparent in the general method illustrated, each processing method involves at least one seamless layer of material 108 that is deposited about the core 102, e.g. block 202. In at least one embodiment, the seamless layer of material 108 is deposited by a method selected from the group consisting of plasma deposition, liquid source mist chemical deposition, flow coating, pad transfer, hydroelectric spray, air spray, and or combinations thereof.

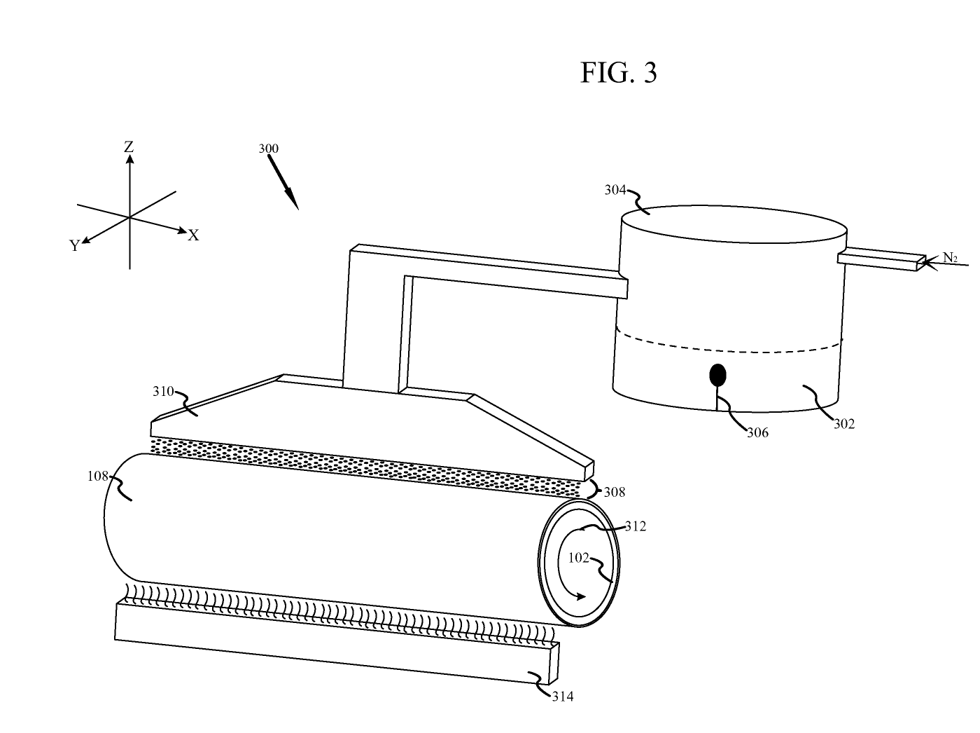

As in at least one embodiment, the seamless layer of material is a high fluorine material such as Teflon® AF, FIG. 3 is provided to illustrate the deposition process 300 of liquid source mist chemical deposition which is suitable for Teflon® AF. This application process is generally described as follows.

Teflon® AF is supplied as a solid (e.g. a powder) that is optically clear. This powder is mixed with selected solvents, such as, but not limited to a halogenated solvent, a perfluorinated solvent and a fluorinated solvent. More specifically, in at least one embodiment a 3M® Fluorinert® Electronic Liquid, such as FC-40, FC-70, or FC-77 can be used as the solvent. The resulting solution 302 is placed in the container 304. An atomizer 306, such as an ultrasonic transducer in the container 304, produces a mist 308. The mist is carried by nitrogen to reach the surface of the cylindrical core 102 by a shower head 310, which is arranged in a linear form and placed close to the surface of the cylindrical core 102.

During the coating process, the cylindrical core 102 is rotating as indicated by arrow 312 so as to allow the uniform seamless layer 108 to accumulate. A linear heating lamp 314 may be arranged to cure the deposited material by driving off the solvent. In at least one embodiment, the coating process is performed so as to establish a uniform seamless layer of material 108 having a minimum thickness of 10 μm.

It is of course understood and appreciated that a similar process may be used to establish the uniform seamless layer 108 consisting of a different material. Further, it is understood and appreciated that such a process may be performed more than once to provide a plurality of uniform seamless layers consisting of the same material or different materials.

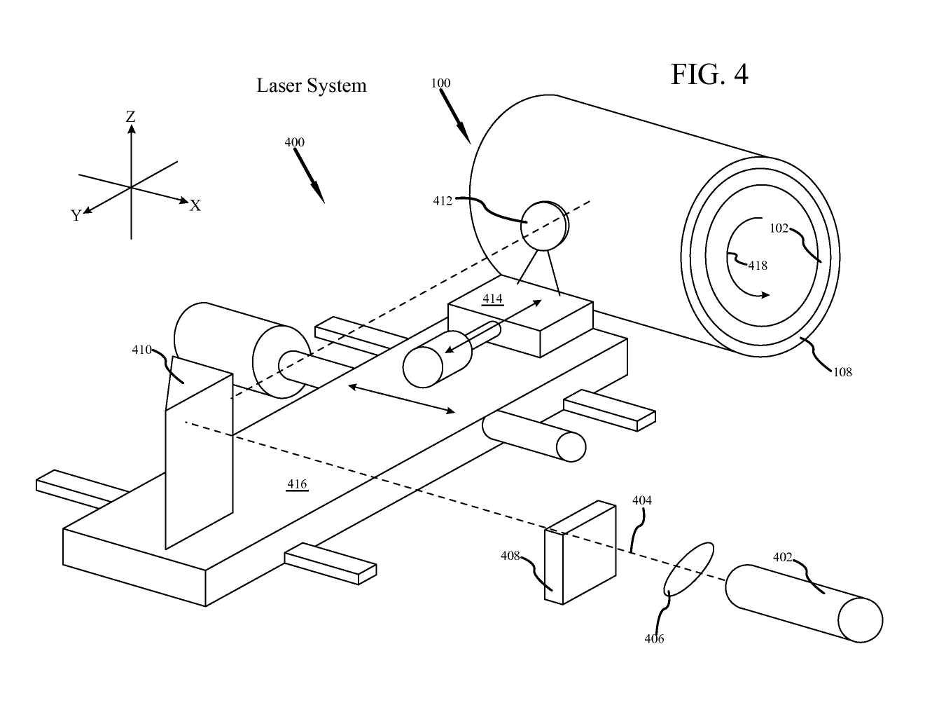

Returning to FIG. 2, within the general processing operation indicated by dotted block 204, a method of processing is selected as indicated by decision 206. In at least one embodiment, this processing method is laser ablation, as indicated by blocks 208 and 210. FIG. 4 is presented to illustrate a general type of laser guidance system 400 that is suitable to laser ablation, as well as other processing methods.

When a pulse laser irradiates a material, photon energy can be absorbed in a localized volume resulting in heat that induces vaporization of a fine portion of the material. Lasers used for micromachining are normally pulsed excimer lasers, such as XeCl (308 nm) or KrCl (222 nm).

In FIG. 4, an appropriate laser 402 provides a beam 404 that is collimated by a lens 406 and presented to a beam modulator 408. The beam modulator 408 is controlled by a computer (not shown) to either transmit or deflect the beam 404. The modulated beam 404 is then deflected by a mirror 410 and focused by an objective lens 412 upon the surface of the seamless layer of material 108. The objective lens 412 is mounted on a Y-stage 414 that can move along the Y-axis so as to adjust the focus distance with respect to the surface of the seamless layer of material 108. The Y-stage 414 and mirror 410 are mounted on an X-stage 416 that can move along the X-axis so as to scan across the surface of the seamless layer of material 108. After each scan, the cylindrical core 102 rotates as indicated by arrow 418 to the next position for a new scan line.

The resolution and precision of the patterns generated by the system 400 can be high. The dimension of the beam spot, d, is determined by d=0.61λ/NA, where NA is the numerical aperture of the imaging system and λ is the wavelength of the laser radiation. With a short wavelength and a large numerical aperture, a feature size of a few microns can advantageously be achieved. The precision of the pattern registration established in the imprint pattern 104 is determined by the precision of the mechanical control of the X-stage 416 and the Y-stage 414 as well as the rotation of the cylindrical core 102.

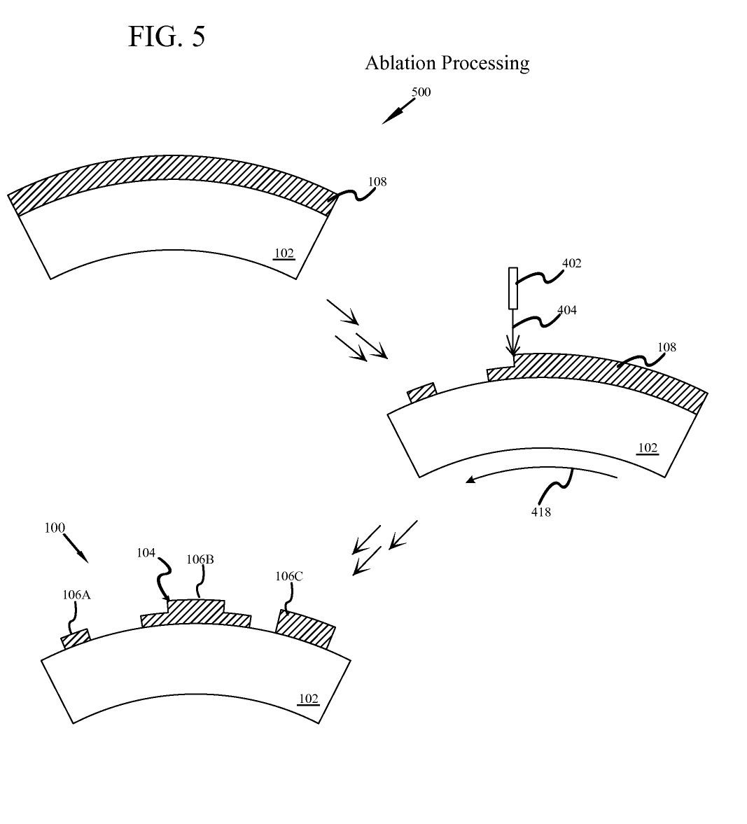

FIG. 5 illustrates a cross sectional side view of the laser ablation processing 500 to produce the three-dimensional pattern 104, and more specifically the structures 106, for a section 120 of the seamless imprint roller 100 shown in FIG. 1. As shown, a seamless layer of material 108 is disposed upon the core 102.

Selective application of the laser beam 404 serves to vaporize portions of the seamless layer of material 108 and provide structures 106, such as 106A˜106C. When the laser ablation processing is complete, the resulting structure is a seamless imprint roller 100 as shown and described above with respect to FIG. 1.

The desired depth profile is achieved by selectively applying repeated pulses to a given spot and/or selectively adjusting the power of each pulse applied to a given spot. Multiple scans may be applied to smooth spot-to-spot transition regions. Where a desired feature size is larger than 50 μm, a laser ablation system based on the raster output scanning system (ROS) can be employed.

It should be noted as well that as the laser beam can be applied substantially perpendicularly to the surface of the seamless layer of material 108, the side wall portions of the resulting structures 106A, 106B and 106C are easily provided as being perpendicular to the surface of the cylindrical core 102, which is desirable for ease release during an imprinting process. This perpendicular alignment is substantially more precise then is often achieved where the imprint pattern is formed on a flat substrate and subsequently rolled and bonded to a cylindrical core.

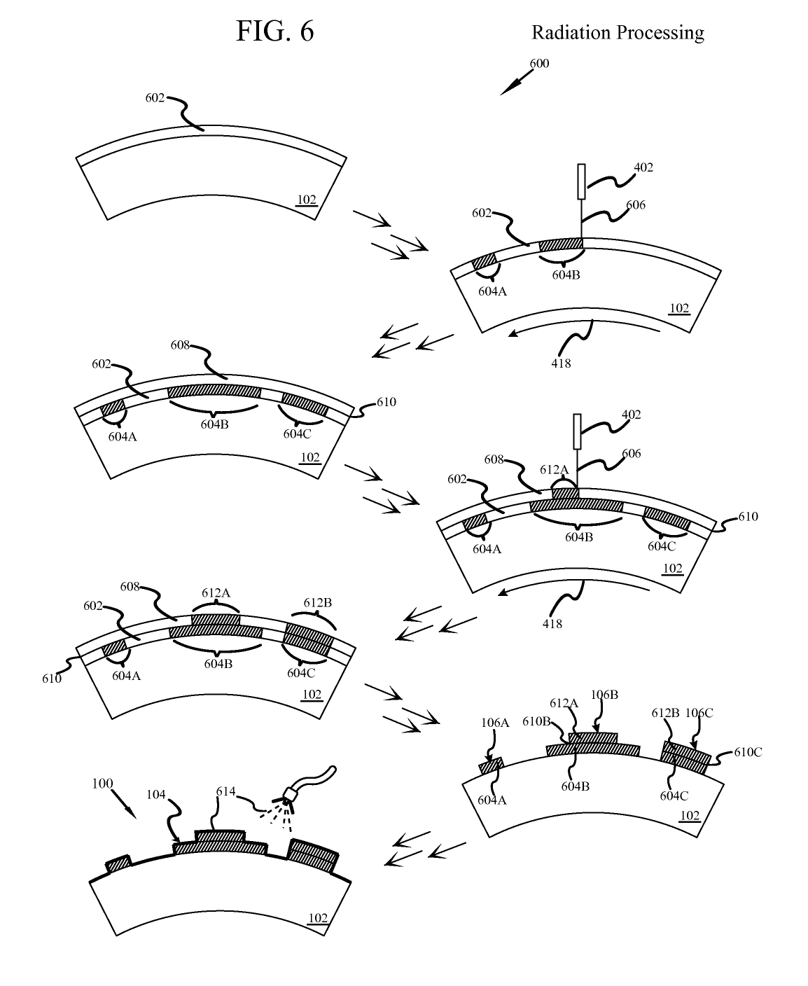

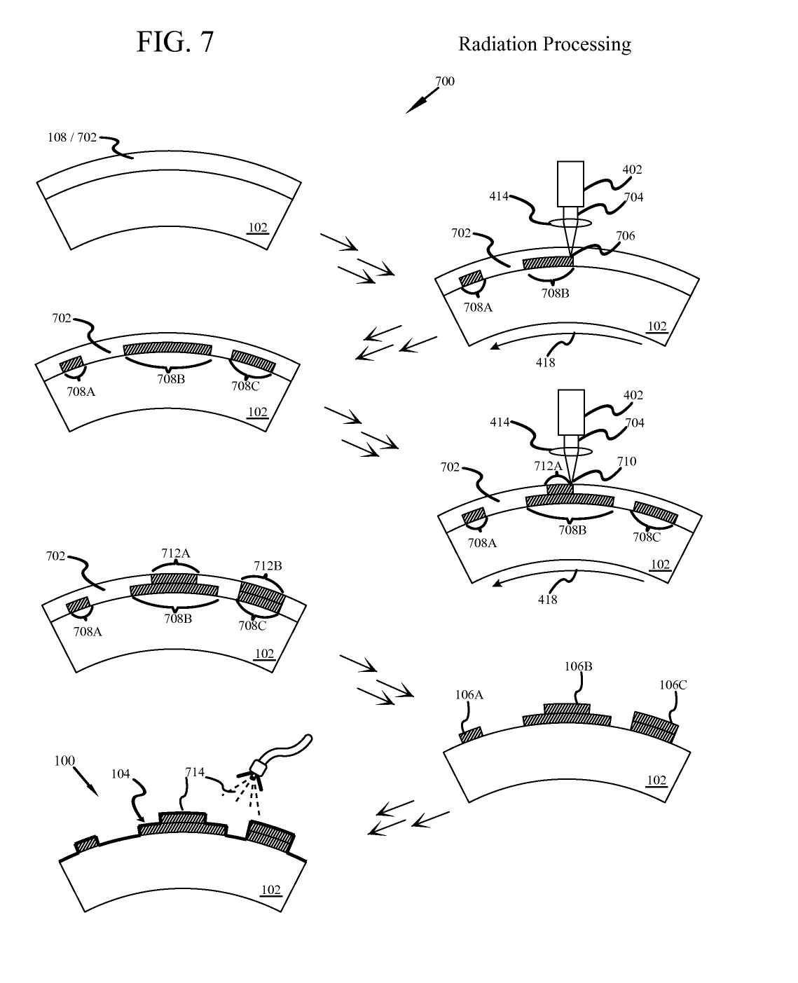

Returning to FIG. 2, at least one alternative processing method is radiation hardening, block 212, which is further described with respect to FIGS. 6 and 7 illustrating at least two variations of a radiation hardening process.

For the first, FIG. 6 provides a cross sectional view of radiation hardening processing 600 to produce the three-dimensional pattern 104, and more specifically the structures 106, for a section 120 of the seamless imprint roller 100 shown in FIG. 1. Initially a first uniform seamless layer 602 of a UV curable elastomer is deposited about the cylindrical core 102. The deposition process may be substantially as described above.

As indicated in block 214, and shown in FIG. 6, at least one area 604 of the first layer 602 is exposed with laser radiation, of which areas 604A˜C are exemplary. The laser radiation is applied in the form of a beam 606 that is applied and controlled substantially as the beam 404 described with respect to FIG. 4 above.

In response to the exposure of laser, the UV curable elastomer undergoes a molecular structural change so as to harden and thus resist a developer agent which when applied will remove the non-exposed portions of the seamless layer of the UV curable elastomer. In at least one embodiment, a reactive volatile monomer is added to a UV curable resin to provide the UV curable elastomer. One such reactive volatile monomer is urethane acrylate.

Following the first patterning, and prior to developing, in at least one embodiment a second seamless layer 608 of a UV curable elastomer is deposited about the first seamless layer 602. It is appreciated that the boundary 610 between the first seamless layer 602 and the second seamless layer 608 is concentric with cylindrical core 102 and does not introduce fabrication complexities and undesirable deformation opportunities as does a perpendicular seam when an initially flat pattern is wrapped around a core and seamed together. As was done with the first layer 602, at least one area 610 of the second layer 608 is exposed with laser radiation, of which areas 612A˜612B are exemplary.

Developing of the first and second seamless layers of UV curable elastomer results in the core structure 106A˜106C, block 216. It is understood and appreciated that these core structures 106A˜106C may well be multi-layered, as cores 106B and 106C are shown to be. However, the apparent boundary 610B, 610C between layer elements 604B, 612A and 604C, 612B respectively is not a perpendicular seam, but rather a junction area that is concentric with cylindrical core 102, and is not akin to the seams transverse to, if not perpendicular to, the center of the cylindrical core as is present in traditional fabrication methods wherein a flat pattern is wrapped and bonded around a cylindrical core. As such, this layering does not qualify as a seam in the imprint pattern as is typically understood to exist when a flat imprint pattern is rolled and bonded to a cylindrical core.

As the UV curable elastomer is likely not also a high fluorine content material, a high fluorine content material is applied 614, block 218. The application of the high fluorine material may employ substantially the same system 300 as shown and described with respect to FIG. 3. Upon coating, the resulting structure is a seamless imprint roller 100 as shown and described above with respect to FIG. 1.

With respect to FIG. 3 it is of course realized that the resulting structures, specifically 106B and 106C are multi layer structures established from exposed areas 604 and 612. As the application of multiple seamless layers of material, layers of UV curable elastomers and multiple radiation processing for each separate layer generally requires precise alignment and re-alignment to insure proper structure formation, in at least one embodiment an alternative radiation processing method 700 is employed, shown in FIG. 7. A reactive volatile monomer is added to a UV curable resin to obtain the desired three dimensional structures by adjusting the thickness loss through percent cure and evaporation (of unreacted volatile monomer) through multiple exposures and hard baking.

Similar to FIG. 6, FIG. 7 provides a cross sectional view of radiation hardening processing 700 to produce the three-dimensional pattern 104, and more specifically the structures 106, for a section 120 of the seamless imprint roller 100 shown in FIG. 1. As shown, a single seamless layer 702 of UV curable elastomer is provided upon the cylindrical core 102. This single seamless layer 702 of UV curable elastomer may be considered as substantially the same as to uniform seamless layer 108 described above and shown in FIG. 1. To achieve the desired three dimensional structures, exposure of different depth layers is accomplished by adjusting the focal point of the UV laser 402.

The lens 414 of FIG. 4 is used to selectively adjust the focal depth of laser beam 704 to a first focal depth 706, such that initially at least one first area 708 of the seamless layer 702 is exposed, of which first areas 708A˜708C are exemplary. Prior to developing, the lens 414 is then adjusted to define a second focal depth 710 that is different from the first focal depth 706. As such, at least one different area 712 of the seamless layer 702 is exposed with laser radiation, of which second areas 712A˜712B are exemplary.

In at least one alternative embodiment, exposure of different depths may also be facilitated by adjusting the UV light exposure times and/or the intensity of the UV light during exposure. Such control may also be employed in the embodiments of FIG. 6 incorporating the multi layer structure.

Developing of the seamless layer 702 of UV curable elastomer results in the core structure 106A˜106C, block 216. As the UV curable elastomer is likely not also a high fluorine content material, a high fluorine content material is applied 714, block 218. The application of the high fluorine material may employ substantially the same system 300 as shown and described with respect to FIG. 3. Upon coating, the resulting structure is a seamless imprint roller 100 as shown and described above with respect to FIG. 1.

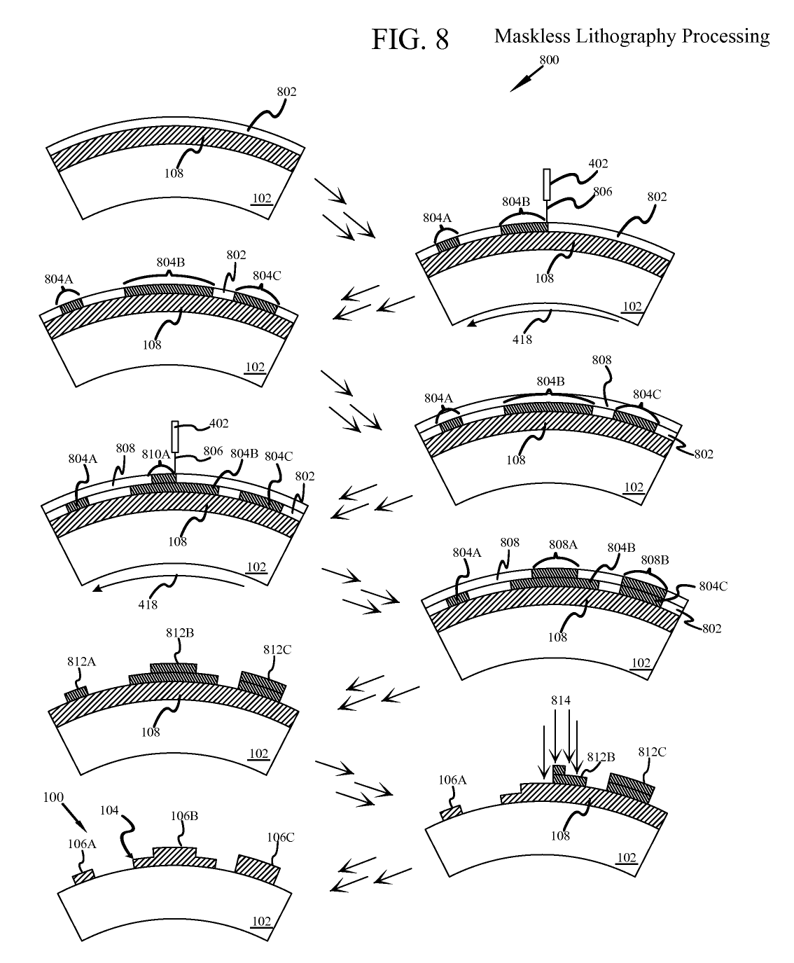

Returning again to FIG. 2, yet at least one other alternative processing method is maskless lithography processing block 220, which is further described with respect to FIG. 8.

In a traditional photolithographic process, a substrate is provided and at least one material layer is uniformly deposited upon the substrate. A photo-resist layer, also commonly known simply as a photoresist or even resist, is deposited upon the material layer. A mask is then placed over the photo resist and light, typically ultra-violet (UV) light, is applied. During the process of exposure, the photoresist undergoes a chemical reaction. Generally the photoresist will react in one of two ways.

With a positive photoresist, UV light changes the chemical structure of the photoresist so that it is soluble in a developer. What “shows” therefore goes, and the mask provides an exact copy of the patterns which are to remain—such as, for example the trace lines of a circuit.

A negative photoresist behaves in the opposite manner, the UV exposure causes it to polymerize and not dissolve in the presence of a developer. As such the mask is a photographic negative of the pattern to be left. Following the developing with either a negative or positive photoresist, blocks of photoresist remain. These blocks may be used to protect portions of the original material layer, serve as isolators or other components.

As shown in FIG. 4 the application of a laser can be very precisely controlled with respect to where and to what degree the laser light is applied to the surface of the seamless layer of material 108. This precision permits the laser to trace a pattern precisely and without the use of a mask as the UV laser light is applied only to precise locations.

FIG. 8 provides a cross sectional view of maskless lithography processing 800 to produce the three-dimensional pattern 104, and more specifically the structures 106, for a section 120 of the seamless imprint roller 100 shown in FIG. 1. Initially a first uniform seamless layer 108 of material such as a high fluorine content material is deposited upon the cylindrical core 102 as described above. Then a first seamless layer of resist material 802 is deposited upon the first uniform seamless layer 108. In at least one embodiment, the first seamless layer of resist material 802 is SU8 Negative Photoresist by MicroChem Corp.

As indicated in block 222, and shown in FIG. 8, at least one area 804 of the first seamless resist layer 802 is exposed with UV laser light, of which areas 804A˜C are exemplary. The UV laser light is applied in the form of a beam 806 that is applied and controlled substantially as beam 404 described with respect to FIG. 4 above.

In response to the exposure of laser the resist undergoes a structural change. As stated above, this may be either a positive resist, chemically changing to harden after exposure to UV light and therefore resist a developer agent; or a negative resist, chemically changing to remain soft after exposure to the UV light so as to remain susceptible to a developer agent. In at least one embodiment the resist is a positive resist.

Following the first patterning and prior to developing, in at least one embodiment a second seamless layer of resist material 808 is deposited about the first seamless layer of resist material 802. In at least one embodiment, the second seamless layer of resist material 808 is SU8 Negative Photoresist by MicroChem Corp. As was done with the first layer 802, at least one area 810 of the second layer 808 is exposed with UV laser light, of which areas 810A˜810B are exemplary.

As indicated in block 224, the first and second resist layers 802 and 808 are developed to provide at least one template structure 812, of which template structures 812A˜812C are exemplary. Moreover, in at least one embodiment where the first and second seamless layers of resist 802 and 808 are SU8 Negative Photoresist by MicroChem Corp, SU8 Developer by MicroChem Corporation is used to remove the unexposed SU8 material and provide template structures 812. These template structures now serve as a self aligned mask for an etching process 814 to define structures 106A˜106C from the material of uniform seamless layer 108.

In at least one embodiment, the etching process indicated by block 226 (FIG. 2) and represented by arrows 814 (FIG. 8) is an assisted physical etching process. In an assisted physical process such as a reactive ion etching process, or RIE, removal of material comes as a combined result of chemical reactions and physical impact. Generally, the ions are accelerated by a voltage applied in a vacuum. The effect of their impact is aided by the introduction of a chemical which reacts with the surface being etched. In other words the reaction attacks and removes the exposed surface layers of the material being etched.

An RIE process advantageously permits very accurate etching of the one or more layers with little appreciable affect upon other layers. In other words, specific selection of different materials permits an RIE process to soften one layer without significantly softening another. It is understood and appreciated that one of ordinary skill in the art will recognize that a variety of different etch processes could be utilized without departing from the scope and spirit herein disclosed.

Whereas the application of the laser 806 is generally on a location point by location point basis so as to define the pattern without a mask, the etching process 814 may be performed more generally across an area as shown by the arrows. Upon completion of the etching process, the resulting structure is a seamless imprint roller 100 as shown and described above with respect to FIG. 1.

It is understood and appreciated that as with radiation hardening processing shown in FIGS. 7 and 8, in at least one embodiment, the template structures 812A˜812C may form the core elements of structures 106A˜106C, the template structures 812A˜812C being coated with a high fluorine content material. In addition, rather than utilizing a plurality of resist layers as shown in FIG. 8, in at least one embodiment, an adjustable lens may be employed to provide a plurality of adjustable focal points corresponding to different depths within a single layer of resist. The multi resist layer processing shown in FIG. 8 has been presented to illustrate yet another form of processing beyond that which may be adapted from the radiation processing methods shown in FIGS. 6 and 7.

To summarize, the above methods provide an advantageous seamless imprint roller 100 as shown in FIG. 1. By rendering the imprint pattern 104 directly upon the cylindrical core 102 the methods entirely avoid the issues of creating an imprint pattern as a flat element that is then rolled, and all of the associated potentially undesirable aspects of deformation and misalignment that can occur with such a rolling and bonding process.

Changes may be made in the above methods, systems, processes and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method of producing a seamless imprint roller, comprising:
providing a translucent cylindrical core;
providing at least one uniform seamless layer of material about the core;
processing the at least one layer of material to define a translucent three dimensional imprint pattern seamlessly disposed about the core, the pattern including at least one structure extending from the core, the structure having one or more elevations.

2. The method of claim 1, wherein the process includes laser ablation of the layer of material, the layer of material being a high fluorine content material selected form the group consisting of a fluoropolymer, an amorphous fluoropolymer, a perfluoropolyether, and fluorinated urethane.

3. The method of claim 2, wherein a desired depth profile is achieved by selectively applying repeated pulses to a given spot, selectively adjusting the power of a pulse applied to a given spot and combinations thereof.

4. The method of claim 1, wherein:
providing at least one uniform seamless layer of material about the core includes:
disposing a first uniform seamless layer of translucent high fluorine material about the core;
disposing a second uniform layer of photoresist about the fluorine layer; and
processing the at least one layer includes:
exposing at least a portion of the photoresist to define a seamless pattern about the core;
developing the exposed photoresist to provide an etching mask upon the first seamless layer;
etching the first seamless layer; and
removing the etching mask to provide a three dimensional imprint pattern seamlessly about the core.

5. The method of claim 1, further including:
disposing a first uniform seamless layer of UV curable elastomer about the core;
exposing at least one portion of the first uniform seamless layer of UV curable elastomer with UV light to define at least a portion of a seamless pattern about the core;
developing the UV curable elastomer to provide at least one structure extending from the core; and
coating the at least one structure with a high fluorine content material to provide a three dimensional imprint pattern seamlessly about the core.

6. The method of claim 5, wherein a first depth of the UV curable elastomer is exposed by adjusting a focal point of a UV laser incident upon the seamless layer to a first location, and a second depth of the UV curable elastomer is exposed by adjusting the focal point of a UV laser incident upon the seamless layer to a second location.

7. The method of claim 5, wherein prior to developing, disposing at least one second uniform seamless layer of UV curable elastomer about the first uniform seamless layer of UV curable elastomer, and exposing at least one portion of the second uniform seamless layer of UV curable elastomer with UV light to further define the seamless pattern about the core.

8. The method of claim 5, wherein a reactive volatile monomer is added to the UV curable resin.

9. The method of claim 1, wherein the at least one uniform seamless layer of material is provided by plasma deposition or liquid source mist chemical deposition.

10. A seamless imprint roller fabricated according to the method as set forth in claim 1.

11. A method of producing a seamless imprint roller, comprising:
providing a UV translucent cylindrical core;
depositing at least one uniform seamless layer of UV translucent material about the core;
processing the at least one layer of material to define a translucent three dimensional imprint pattern seamlessly disposed about the core, the pattern including at least one structure extending from the core, the structure having one or more elevations, at least the outer surface of the imprint pattern consisting of a high fluorine content material selected from the group of a fluoropolymer, an amorphous fluoropolymer, a perfluoropolyether, and fluorinated urethane, and the form of processing being selected from the group consisting of laser ablation processing, radiation hardening processing and photolithography processing.

12. The method of claim 11, wherein the seamless three dimensional imprint pattern consists of UV cured elastomer disposed upon the core and coated with a high fluorine content material.

13. The method of claim 11, wherein the seamless three dimensional imprint pattern is a high fluorine content material.

14. A seamless imprint roller fabricated according to the method as set forth in claim 11.

15. A seamless imprint roller, comprising:
a translucent cylindrical core; and
a translucent three dimensional inherently aligned imprint pattern seamlessly disposed about the core, the pattern including at least one structure extending from the core, the structure having one or more elevations, at least the outer surface of the imprint pattern consisting of a high fluorine content material selected from the group of a fluoropolymer, an amorphous fluoropolymer, a perfluoropolyether, and a fluorinated urethane

16. The seamless imprint roller of claim 15, wherein the seamless three dimensional imprint pattern consists of UV cured elastomer disposed upon the core and coated with a high fluorine content material.

17. The seamless imprint roller of claim 15, wherein the seamless three dimensional imprint pattern is a high fluorine content material.

18. The seamless imprint roller of claim 15, wherein the three dimensional pattern is formed directly upon the core and is therefore seamless.

19. The seamless imprint roller of claim 15, wherein the seamless imprint roller is provided by:
providing a translucent cylindrical core;
providing at least one uniform seamless layer of material about the core;
processing the at least one layer of material to define a translucent three dimensional imprint pattern seamlessly disposed about the core, the pattern including at least one structure extending from the core, the structure having one or more elevations.

20. A seamless imprint roller fabricated according to the method as set forth in claim 15.
